(19) United States
(12) Patent Application Publication
(10) Pub. No.: US 2021/0091359 A1
(43) Pub. Date: Mar. 25, 2021

(54) BAG-SHAPED SEPARATOR FOR ELECTRIC STORAGE DEVICE, THERMAL BONDING METHOD AND THERMAL BONDING DEVICE THEREFOR, AND ELECTRIC STORAGE DEVICE

(71) Applicant: NEC CORPORATION, Tokyo (JP)

(72) Inventor: Kenichi SHIMURA, Tokyo (JP)

(73) Assignee: NEC CORPORATION, Tokyo (JP)

(21) Appl. No.: 16/630,256

(22) PCT Filed: May 29, 2018
(86) PCT No.: PCT/JP2018/020463

§ 371 Date: Jan. 10, 2020

(30) Foreign Application Priority Data
Jul. 14, 2017 (JP) 2017-138018

(51) Int. Cl. H01M 2/18; H01M 2/16; H01M 2/14; H01M 10/0525

(52) U.S. Cl. CPC H01M 2/18; H01M 2/1686; H01M 10/0525; H01M 2/145; H01M 2/162

(57) ABSTRACT

The present invention provides a bag-shaped separator made of a separator material containing a material having the softening or melting point with a thermally bonded portion less susceptible to breakage, a thermal bonding method and a thermal bonding device therefor, and an electric storage device. The bag-shaped separator is formed with two sheets of a separator material with piled or a one sheet of the separator material with folded and piled. The separator material includes a polymer material having a melting or softening point and has one or more thermal bonding regions 30 at the edge of piled separator materials. The thermal bonding region 30 includes a fused region 31 where the separator material solidifies again after melting or softening, and a region 32 where the fusion rate of the polymer material decreases continuously from the fused region 31 toward a region 34 adjacent to the thermal bonding region 30.

### FIELD OF THE INVENTION

The present invention relates to a bag-shaped separator for an electric storage device, a thermal bonding method thereof and a thermal bonding device therefor. The present invention also relates to the electric storage device including the bag-shaped separator.

### BACKGROUND ART

Non-aqueous electrolyte secondary batteries, such as lithium-ion secondary batteries, have already been put into practical use as batteries for notebook computers and mobile phones due to advantages such as high energy density, low self-discharge and excellent long-term reliability. In recent years, advanced functions of electronic devices and use in electric vehicles have progressed, and development of lithium ion secondary batteries with higher energy density has been demanded.

In a lithium ion secondary battery, if charging proceeds beyond a predetermined voltage due to an abnormality in the control system or a large current is released due to a short circuit outside the battery, the entire battery may generate heat. Alternatively, if a conductive foreign substance is mixed in the battery or penetrates from the outside, a local short circuit occurs inside the battery, and a short circuit current may flow to generate heat. When the separator is damaged by this heat, a positive electrode plate and a negative electrode plate are short-circuited in a wide range, which may lead to smoke from the battery or battery explosion. In a lithium ion battery having a high energy density, a short-circuit current at the time of abnormality is increased, so that the separator is required to have high heat resistance.

As a separator having high heat resistance, microporous membranes or nonwoven fabrics of polymer materials such as polyethylene terephthalate (PET) having higher heat softening temperature, melting point and thermal decomposition temperature than polyethylene (PE) and polypropylene (PP) conventionally used as separator materials, or aromatic polyamide (aramid), polyimide and polyphenylene sulfide (PPS) have been developed.

For example, Patent Document 1 discloses a PET nonwoven fabric, Patent Document 2 discloses an aramid microporous membrane, Patent Document 3 discloses a polyimide or aramid nonwoven fabric, and Patent Document 4 discloses a PPS nonwoven fabric.

The occurrence of an internal short circuit in a lithium ion battery exposed to a high temperature is considered to be related not only to the damage of the separator but also to the positional relationship between the electrode body and the separator. For example, when the electrode body is deformed, the positions of the electrode and the separator may be shifted and the positive electrode plate and the negative electrode plate may be short-circuited. Therefore, not only the heat-resistant separator but also prevention of displacement between the electrode and the separator is required to improve the safety of the battery at a high temperature.

Forming the separator in a bag-shape and accommodating at least one of the positive electrode plate and the negative electrode plate therein is also effective for preventing the displacement between the electrode and the separator when the electrode body is deformed (Patent Documents 5 to 7). Since at least one of the positive electrode plate and the negative electrode plate is accommodated in the bag-shaped separator, it can be prevented to contact the positive electrode plate with the negative electrode plate even if the electrode body is deformed.

In order to manufacture a bag-shaped separator, for example, as disclosed in Patent Documents 5 and 6, in a separator made of PE or PP, a temperature-controlled heater block is pressed to prepare a bag-shaped separator.

On the other hand, Patent Document 7 uses a high heat-resistant fiber assembly having a melting point of 150° C. or higher, preferably 240° C. or higher, and includes a fiber that does not exhibit a melting point. In this document, it is shown that separator films containing fibers of aramid or polyimide are heat-welded at a high temperature of 400° C. to 600° C. to be processed into a bag-shaped separator.

In the present specification, the case where the separator is melted and fixed by heat and the case where the separator is softened by heat and fixed by applying force may be referred to as “thermal bonding” without distinction.

### PRIOR ART DOCUMENTS

### Patent Documents

Patent Document 1: WO2014/123033 A1

Patent Document 2: WO2013/105300 A1

Patent Document 3: JP2014-25171 A

Patent Document 4: WO2012/033085 A1

Patent Document 5: JPH07-302616 A

Patent Document 6: JPH07-272761 A

Patent Document 7: JP2006-59717 A

### SUMMARY OF INVENTION

### Problems to be Solved by the Invention

In the thermal bonding of the high heat resistance separator described in Patent Document 7, it is difficult to control the heat applied to the separator as compared with the thermal bonding of PE and PP described in Patent Documents 5 and 6. Since the temperature of the protrusion (hereinafter referred to as a heating tip) that gives the heat of the heater to the separator is high, a lot of heat is dissipated due to the temperature difference with a support stage that holds the separator during thermal bonding, and therefore, the temperature drop is large. If the temperature of the heating tip falls below the softening temperature or melting point of the separator, the separator cannot be thermally bonded, so precise temperature control is required. On the other hand, if the temperature of the heating tip is too high, the separator contacted by the heating tip is completely melted and a hole is opened, so that the place where the separators are fixed is only the edges of the holes, and the bonding strength is lowered.

Since the volume of the region where the separator material is thermally bonded is reduced by melting or compression-deforming of the separator material, the structure of the separator material becomes discontinuous at the boundary between the thermally bonded region and the periphery. Therefore, when an external force is applied, the separator material may break at the contour of the thermally bonding region. Particularly, in the case of the separator material made of nonwoven fabric, the melted or softened fiber is stretched and thinned at the contour of the thermally bonded region, so that the fracture occurs at the contour of the thermally bonded region compared to the separator material made of a porous membrane.

Accordingly, in view of the above-described problems, an object of the present invention is to provide a bag-shaped separator that is made of a separator material containing a polymer material having a softening point or a melting point, and is hard to break at a thermally bonded portion, and to provide a thermal bonding method and a thermal bonding device therefor, and an electric storage device.

### Means for Dissolving the Problems

A bag-shaped separator according to the present invention is formed from two sheets of a separator material with piled or one sheet of the separator material with folded and piled,

wherein the separator material includes a polymer material having a melting point or a softening point,

wherein one or more thermal bonding regions are provided at the edge of the separator material, and

wherein the thermal bonding region includes a fused region in which the separator material is solidified again after melting or softening, and a region in which the fusion rate of the polymer material continuously decreases toward a region adjacent to the thermal bonding region from the fused region.

A power storage device according to the present invention includes:

an electrode stack in which the above-described bag-shaped separator accommodating an electrode plate and another electrode plate having a polarity different from that of the electrode plate accommodated in the bag-shaped separator are stacked.

A thermal bonding method according to the present invention is a method for thermally bonding piled separator materials that includes a polymer material having a melting point or a softening point, the method including:

forming
a high temperature region heated at a first temperature higher than the melting point or softening point in a region where the piled separator materials are thermally bonded during the thermal bonding,
a low temperature region heated at a temperature lower than the first temperature and not higher than the melting point or softening point at a peripheral portion of the region to be thermally bonded, and
an intermediate region where the temperature changes from the high temperature region toward the low temperature region.

A thermal bonding device according to the present invention is a thermal bonding device for bonding a first separator material and a second separator material that are piled, including:

a heating tip that abuts the first separator material and heats the first separator material,

a support stage that contacts the second separator material and supports the piled separator materials,

wherein the heating tip includes a core portion made of a material having relatively high thermal conductivity, and a covering portion made of a material having a relatively low thermal conductivity that covers at least a part of the core portion, and

wherein a heating surface of the heating tip that contacts the surface of the first separator material includes both of the core portion and the covering portion.

A thermal bonding device according to the present invention is a thermal bonding device for bonding a first separator material and a second separator material that are piled, including:

a heating tip that abuts the first separator material and heats the first separator material, and

a support stage that contacts the second separator material for supporting the piled separator materials,

wherein a region opposed to the heating tip on the surface of the support stage contacting the second separator material includes a region having relatively low thermal conductivity and a region having relatively high thermal conductivity, and the region having low thermal conductivity is disposed inside the region having high thermal conductivity.

### Advantage of the Invention

According to the present invention, the bag-shaped separator is made of a separator material containing the polymeric material which has a softening point or melting point, and hard to break at a thermal bonding portion, and to provide a thermal bonding method and a thermal bonding device therefor. Moreover, according to this invention, the electrical storage device which can prevent reliably contact of a positive electrode plate and a negative electrode plate using this bag-shaped separator can be provided.

### BRIEF DESCRIPTION OF THE DRAWINGS

FIG. 1 is a diagram which shows typically a basic structure of a battery which has a film exterior;

FIG. 2 is a schematic diagram explaining the electrode stack of FIG. 1;

FIG. 3 is a schematic diagram explaining the temperature distribution of the thermal bonding region of the separator material which concerns on an embodiment of the present invention;

FIG. 4(a) is a front view which shows typically the thermal bonding device of the separator material according to an embodiment of the present invention, FIG. 4(b) is a side view thereof;

FIG. 5(a) is sectional view which shows typically the heating tip in one embodiment of the present invention, (b) is a front view of a contact surface;

FIG. 6(a) is sectional view which shows typically the heating tip in other embodiment of the present invention, (b) is a front view of a contact surface;

FIG. 7 is a diagram which shows typically the structure of the support stage in one embodiment of the present invention;

FIG. 8(a) is sectional view which schematically shows the heating tip of Example 1, (b) is a front view of a contact surface;

FIG. 9 is a microscopic image showing a thermal bonding point of Example 1;

FIG. 10 is an SEM observation image showing a cross section of a thermal bonding point of Example 1;

FIG. 11(a) is a top view of the thermal bonding point of Example 1, (b) is a schematic cross section view thereof;

FIG. 12 is a microscope image which shows the thermal bonding point of Example 2;

FIG. 13 is a microscope image which shows the thermal bonding point of Comparative Example 1; and

FIG. 14 is a microscopic image showing the thermal bonding point of Comparative Example 2.

### EXAMPLE EMBODIMENT

An outline of the embodiment will be described. The method of thermally bonding the separator material according to the embodiment includes stacking two separator materials containing a polymer material that is softened or melted by heat, or folding and stacking one separator material, a heating tip is pressed to a portion of the piled separator material to be bonded, and the separator material is heated so as to have a temperature distribution in a region in contact with the heating tip, and the overlapped separator material is thermally bonded. Here, the separator material on the side in contact with the heating tip may be referred to as the first separator material, and the separator material on the side in contact with the support stage that supports the piled separator materials may be referred to as the second separator material. The same applies for convenience when one separator material is folded and piled.

When the polymer material contained in the separator material has a melting point, the maximum temperature is higher than the melting point for at least one of the polymer materials having the melting point in the region of the separator material in contact with the heating tip, and the temperature of the separator material is set to be equal to or lower than the melting point in at least a part of the outer edge portion of the contact region. Hereinafter, the region in contact with the heating tip of the separator material may be referred to as a thermal bonding region or a contact region of the separator material.

When the polymer material contained in the separator material does not have a melting point and has a heat softening temperature (softening point), the maximum temperature is set higher than the heat softening temperature of at least one polymer material having a heat softening temperature in the contact region of the separator material, and the temperature of at least a part of the separator material at the outer edge of the contact region of the separator material is set to be equal to or lower than the heat softening temperature.

When the polymer material contained in the separator material has both a melting point and a softening point, or when a polymer material having a melting point and a polymer material having a softening temperature without a melting point are mixed, the separator material is treated as follows. For at least one of the polymer materials having a melting point, the maximum temperature should be higher than the melting point, and the temperature of the separator material should be equal to or lower than the heat softening temperature of the polymer material on at least a part of the outer edge of the contact region of the separator material. Alternatively, in the contact region of the separator material, the maximum temperature is set higher than the heat softening temperature for at least one of the polymer materials having no melting point and having a heat softening temperature, and the temperature of the separator material of at least a part of the outer edge of the contact region of the separator material is set to be equal to or lower than the heat softening temperature.

A thermal bonding device for a separator material according to an embodiment includes a heater, a heating tip thermally connected to the heater, and a support stage that supports the separator material when the heating tip is brought into contact with the separator material. The heating tip is formed of, for example, a combination of materials being different in thermal conductivity. Alternatively, the heat conduction path from the heater to the contact surface with the separator material has a notch or a heat dissipation structure. Thus, the amount of heat transmitted from the heater to the surface of the heating tip has a distribution within the surface of the heating tip, and the separator material in contact with the heating tip also has a temperature distribution. Alternatively, the support stage has a distribution of thermal conductivity in a region facing the heating tip. In the region where the thermal conductivity of the support stage is high, the diffusion of heat given from the heating tip to the separator material is large, so the temperature rise of the separator material is slow, and in the region where the thermal conductivity of the support stage is low and there is little heat dissipation, so the temperature rise of the separator is fast. As a result, even when there is no temperature distribution on the heating surface of the heating tip in contact with the separator material, temperature distribution occurs in the contact region of the separator material.

Hereinafter, the bag-shaped separator of this embodiment and a battery including the same will be described for each configuration with reference to the drawings. It should be noted that the size and ratio of each member in the drawings may differ from the actual size and ratio for convenience of explanation.

### <Separator Material>

Separator material (hereinafter, also simply referred to as “separator”) includes polymer materials that are melted or softened by heat (i.e., polymer materials having a melting point or softening point). In particular, a polymer material having a melting point or softening point of 200° C. or higher is preferably included. Specific examples thereof include aromatic polyamides (aramid), polyimides, polyamideimides, polyethylene terephthalates (PET), polybutylene terephthalates (PBT), and polyphenylene sulfides (PPS). In addition to the polymer material that is melted or softened by heat, a polymer material that does not show melting or softening point by heat, such as cellulose, or an inorganic material such as glass can be included.

The thickness of the separator is preferably 25 μm or less, more preferably 15 μm or less, for a battery having a high energy density. There is no particular restriction on the structure of the separator, and any of a nonwoven fabric, a woven fabric, and a porous membrane may be used. Particularly preferred are woven fabrics and nonwoven fabrics made of polymer fibers.

The air permeability of the separator is preferably high from the view point of the charge and discharge characteristics, in particular, in order to obtain a large charge current and discharge current at a low temperature. Specifically, the separator in a state in which no organic material is supported, the Gurley value (second/100 ml) serving as a measure of the air permeability is preferably 200 or less, and more preferably 100 or less.

### <Thermal Bonding Method of the Separator>

A thermal bonding method of the separator according to an embodiment of the present invention will be described.

Two sheets of a separator including a polymer material that is melted or softened by heat are piled, or one sheet of the separator is folded and piled. Then, the heating tip is pressed on (abutted on) the place to be bonded, and heated so as to have a temperature distribution in the contact region (thermal bonding region) of the separator. Having a temperature distribution means forming a continuous temperature gradient (having gentle gradient) from a temperature higher than the melting point or softening point to a temperature below the melting point or softening point. Thereby, the overlapped separators are thermally bonded. In addition, although the whole region where a heating tip contacts a separator does not become a region which is completely heat-bonded (melt-bonded), the region where a heating tip contacts and is heated is also called a heat-bonding region. In the bonding step, a heating tip heated in advance with a heater may be pressed on the thermal bonding region of the separator. Alternatively, the heating tip may be heated with a pulse heater or the like after the heating tip is pressed on the thermal bonding region of the separator. One or more thermal bonding regions are provided on the edge of the piled separator.

When the polymer material contained in the separator has a melting point, the maximum temperature in the thermal bonding region of the separator is higher than the melting point for at least one of the polymeric materials having the melting point, and the temperature of at least a part of the outer edge (outer peripheral end) is set to be equal to or lower than the melting point.

As a result, a portion where the polymer material is melted and a portion where the polymer material is not melted exist in the thermal bonding region of the separator, and a region satisfying a temperature condition suitable for thermal bonding is generated therebetween. In addition, the melting state of the polymer material (melting rate, that is, the ratio of the portion once melted or softened and then solidified) is continuously changed from the higher temperature side (for example, the inner side) to the lower temperature side (for example, the outer side). Continuously means that the direction of change is constant and the rate of change is gradual. It does not necessarily change at a constant rate. This rate of change is small compared to at least the rate of change of discontinuities in the prior art. For this reason, it is possible to avoid breakage due to discontinuous portions in the structure of the separator at the contour of the thermal bonding region as in the prior art. This is because in the discontinuous portion, the melted or softened fiber is stretched to become thin and the strength is lowered. This melting rate can be obtained by taking an enlarged image of an arbitrary bonding portion and measuring the proportion of the portion where the material does not have the original shape.

The fact that the melting rate changes continuously includes the case where the melting rate changes stepwise. The direction of change is constant. That is, the melting rate is changed sequentially or stepwise from a portion with a high melting rate toward a portion with a low melting rate in a certain direction, and a portion with a high melting rate and a portion with a low melting rate are not mixed alternately. The stepwise changes occur in multiple steps. For example, the change may be in 2 steps or more, further 3 steps or more, or still further 4 steps or more.

In order to have such a temperature gradient, it is preferable that the temperature of the outer edge portion of the thermal bonding region of the separator is equal to or lower than the melting point of the polymer material included in the separator. However, depending on the structure of the heating tip and the support stage, the temperature of the outer edge portion of the thermal bonding region of the separator may not be lower than the melting point of the polymer material included in the separator. In this case, the temperature of the outer edge portion of the thermal bonding region may be lower than the temperature of the high temperature region heated to a temperature higher than the melting point. The size of the region where the polymer material is melted and bonded is smaller than the region where the heating tip contacts the separator.

When the polymer material contained in the separator does not have a melting point and has a heat softening temperature, the maximum temperature in the thermal bonding region of the separator is heated to higher than the heat softening temperature for at least one of the polymer materials having a heat softening temperature and at least a part of the outer edge portion of the thermal bonding region is set to be equal to or lower than the heat softening temperature.

As a result, a portion where the polymer material is softened and a portion where the polymer material is not softened exist in the heat bonding region of the separator, and a region satisfying a temperature condition suitable for heat bonding is generated in the region therebetween. In addition, since the change in the melting rate of the separator is continuous around the fused region where the fibers are completely softened (melted) and solidified after the fibers are integrated, it is possible to avoid breakage due to the occurrence of discontinuous portions with reduced strength of the separator around the fused region.

It is preferable that the temperature of the outer edge portion of the thermal bonding region where the heating tip contacts the separator is equal to or lower than the thermal softening temperature of the polymer material included in the separator. However, depending on the structure of the heating tip and the support stage, the temperature of the outer edge portion of the thermal bonding region of the separator may not be equal to or lower than the softening point of the polymer material included in the separator. In this case, the temperature of the outer edge portion of the thermal bonding region may be lower than the temperature of the high temperature region heated to a temperature higher than the softening point. The size of the region where the polymer material is softened by heat and bonded is smaller than the region where the heating tip contacts the separator.

In the case where the polymer material contained in the separator has both a melting point and a softening temperature, or in the case where the polymer material includes a polymer material having a melting point and a polymer material having a softening temperature, any one of methods described above for the case of the polymer material has a melting point and for the case of the polymer material has a softening point can be used. When the polymer material is melted and bonded, the bonding strength per bonded area is higher. However, due to the required bonding strength and the conditions such as the melting point of the polymer material and the abundance in the separator, either a method in the case of having a melting point or a method in the case of a softening point is selected.

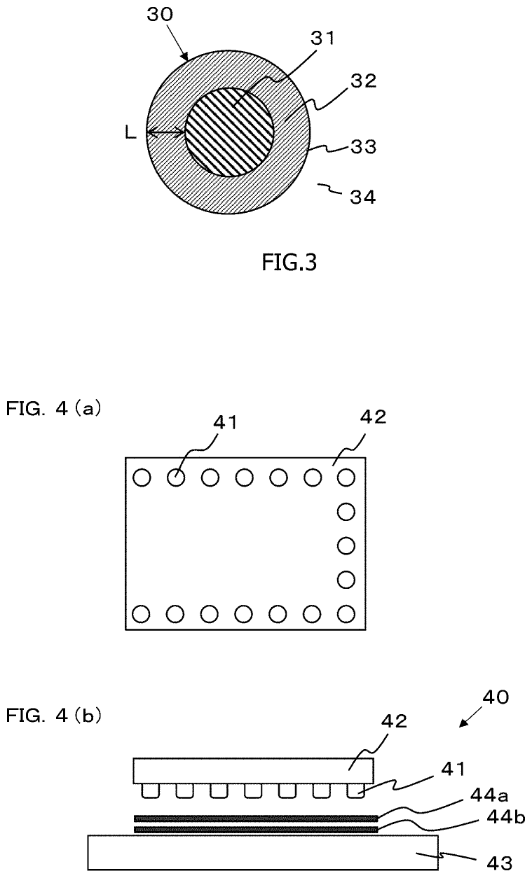

In FIG. 3, the example of the temperature distribution of the thermal bonding region (area where a heating tip contacts) of a separator in the thermal bonding method of this embodiment is shown. The thermal bonding region 30 includes a high temperature region 31, an outer edge portion 33, and an intermediate region 32 between them. The outside of the outer edge portion 33 is a region 34 adjacent to the heat bonding region 30. The heating temperature is high in the high temperature region 31 and low in the outer edge portion 33. The intermediate region 32 is a region having a temperature between the high temperature region 31 and the outer edge portion 33, and the temperature continuously changes (the temperature gradually decreases) from the high temperature region 31 to the outer edge portion 33.

When the polymer material contained in the separator has a melting point, the temperature applied to the separator in the high temperature region 31 of FIG. 3 is preferably higher than the melting point of the polymer material. In that case, the applied temperature in the outer edge portion 33 periphery where the heating tip contacts is preferably equal to or lower than the melting point of the polymer material. The temperature of the intermediate region 32 is a temperature between the temperature of high temperature region 31 and the temperature of the outer edge portion 33. Inside the high temperature region 31 where the temperature exceeds the melting point of the polymer material, the polymer material melts and the separator is thermally bonded. A hole may be partially opened inside the high temperature region 31. From the hole formed inside the high temperature region 31, it can be known that the two piled separators are completely melted inside the high temperature region 31. On the other hand, since the hole does not contribute to the bonding strength of the separator, as an example, the temperature distribution is such that the area of the hole is smaller than the melted area of the separator.

When the polymer material contained in the separator has a heat softening temperature, the temperature applied to the separator in the high temperature region 31of FIG. 3 is preferably higher than the heat softening temperature of the polymer material and the applied temperature in the outer edge portion 33 is preferably equal to or lower than the heat softening temperature. The temperature of the intermediate region 32 is a temperature between the temperature of high temperature region 31 and the temperature of the outer edge portion 33. When thermal bonding is performed, the separator is softened inside the high temperature region 31, receives pressure from the heating tip, and is fixed by entering into the voids or pores of the fiber of the other separator.

FIG. 3 shows an example in which the high temperature region 31 is the center of the thermal bonding region 30 of the separator as the temperature distribution of the separator, but a distribution in which the high temperature region 31 is shifted from the center of the thermal bonding region 30 can also be used. Further, the planar shape of the thermal bonding region 30 is not limited to the circular shape illustrated in FIG. 3, and can be used according to the shape of the portion to be bonded, such as an oval shape, a square shape, or an L shape.

In the thermal bonding region 30 of the thermally bonded separator, the following structural change occurs. That is, in the thermal bonding region 30, a fused region (corresponding to the high-temperature region 31) where the separator is completely melted or softened and the whole is fused and then the temperature is lowered and then solidified again and a region (intermediate region 32) in which the fusion rate continuously decreases from the fused region 31 toward the region 34 adjacent to the thermally bonding region 30 are formed. The state in which the two separators are completely melted together is defined as a fusion rate of 100%. In contrast, the state which is not fused at all is defined as a fusion rate of 0%. When the polymer material of the separator is fused and bonded by heat, the apparent volume decreases as the fusion rate increases. In the intermediate region 32, the fusion rate decreases toward the region 34, so that the apparent volume increases and the thickness increases. As a result, in the intermediate region 32, the thickness gradually increases from the fused region 31 toward the region 34 adjacent to the thermal bonding region 30. Note that the fused region 31 may have an opening (that is, a region having a thickness of zero).

The fusion rate of the intermediate region 32 is preferably changed from 100% to 0% at a distance equal to or greater than the thickness before bonding two sheets of the separators. That is, it is preferable that the radial length (distance in the thickness changing direction) L of the intermediate region 32 is equal to or greater than the thickness of the two sheets of the separators before bonding. By gradually changing the fusion rate from 100% to 0% with such a change amount, the two sheets of the separators can be thermally bonded without forming a portion where the strength decreases.

From another viewpoint, when the thickness gradually increases from the fused region 31 toward the region 34 adjacent to the thermal bonding region 30, the porosity of the two bonded separators gradually increases. That is, in the fused region 31, the two sheets of the separators are fused and bonded with a porosity of approximately 0% (fusion rate of 100%). This porosity gradually increases toward the adjacent region 34, and becomes the porosity (fusion rate 0%) of the separator before bonding in the region 34 where the fusion rate is 0%. The porosity can be calculated by taking an enlarged image of the cross section of the separator and obtaining each area of the fiber portion and the space portion by image analysis. Alternatively, the porosity can be obtained from the specific gravity of a fiber and the apparent specific gravity of a separator. The amount of change in porosity is equal to the amount of change in fusion rate with the sign ±reversed.

When the material resin of the separator is melted or softened and the separator is thermally bonded, the material resin fills the voids that the separator had before bonding. Theoretically, the separator becomes a resin film having a porosity of 0% in the fused portion where the resin completely melted or softened. The thickness is “initial thickness×[100−initial porosity (%)]/100”. In practice, however, the melted or softened resin moves in the in-plane direction, or conversely, the voids are not completely blocked, so that the calculated value is about the same or less.

Further, when the fusion rate continuously decreases, the transparency may gradually decrease from the fused region 31 toward the region 34 adjacent to the thermal bonding region 30. In other words, a translucent area appears. This is because, for example, as the polymer material melts or softens and the fusion rate increases, the diffuse reflection of light decreases and the transmittance increases. The change in transparency can be observed by seeing through the colored background.

In addition, for example, when the separator has a fiber structure of a polymer material, the proportion of fibers integrated by melting or softening from the fused region 31 toward the region 34 adjacent to the thermal bonding region 30 gradually decreases. This is because the lower the temperature, the lower the proportion of fibers that are melted or softened and integrated. The ratio of the integrated fibers is synonymous with the fusion rate.

In the thermal bonding region as shown in FIG. 3, the fused region 31 is in the center, and the intermediate region 32 is around the fused region 31. However, the arrangement of the fused region 31 and the intermediate region 32 is not limited to this.

### <Thermal Bonding Device>

FIG. 4 is a schematic diagram for explaining the thermal bonding device. The separator to be bonded may be a stack of two sheets of separators or a stack of one separator with folded. In the following description, it is assumed that two sheets of separators are piled. FIG. 4(a) shows a front view of the heater block 42 provided with the heating tip 41. FIG. 4(b) is a side view thereof. The thermal bonding device 40 includes a support stage 43 that supports a first separator 44a (upper separator) and a second separator 44b (lower separator) to be thermally bonded, and a heater block 42 including a heating tip 41. By using the heater block 42 provided with a plurality of heating tips 41, a plurality of thermal bonding points can be formed simultaneously. In FIG. 4(a), as an example, heating tips 41 are arranged in a U-shape in order to bond three sides excluding an opening into which an electrode plate is inserted. The heater block 42 includes a heater (not shown) that heats the heating tips 41. The thermal bonding device 40 includes a mechanism (not shown) that moves the heater block 42 relative to the support stage in order to bring the heating tip 41 into contact with the first separator on the support stage 43.

At least one of the heating tip 41 and the support stage 43 of the thermal bonding device 40 in the present embodiment has a structure described below.

### (Heating Tip)

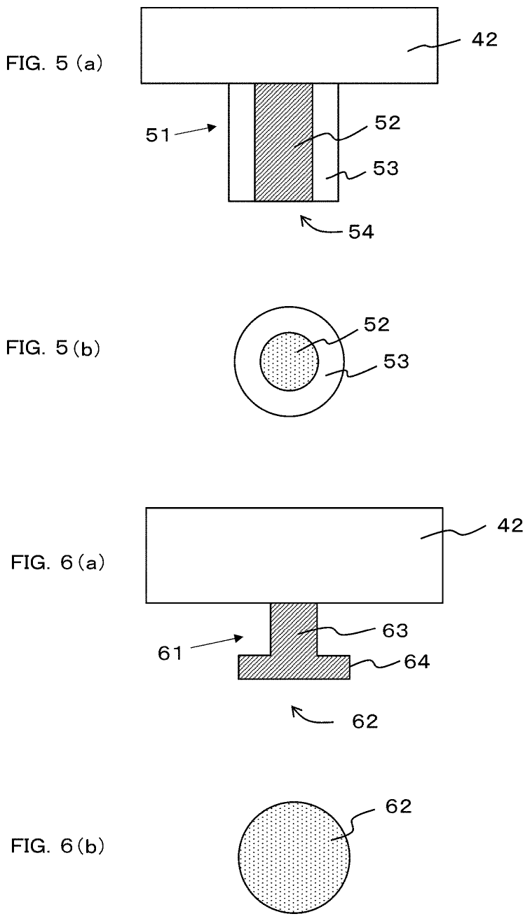

FIG. 5 is a schematic diagram for explaining the structure of the heating tip 51 in one embodiment of the thermal bonding device of the present invention. FIG. 5(a) is a longitudinal sectional view from the side, and FIG. 5(b) is a front view of a contact surface (heating surface) 54 of the heating tip 51 that contacts the separator. The heating tip 51 is formed by combining materials having different thermal conductivities. In FIG. 5, a low-heat conductive material 53 having a relatively low thermal conductivity is provided outside a high-heat conductive material 52 having a relatively high thermal conductivity. Since the temperature of the high-heat conductive material 52 becomes higher than the temperature of the low-heat conductive material 53, a temperature distribution can be generated on the heating surface 54 of the heating tip 51 that contacts the separator. As a result, the temperature distribution shown in FIG. 3 occurs in the contact region of the separator with which the heating surface 54 is in contact.

The size of the high-temperature region 31 in FIG. 3 does not necessarily match the size of the region of the material 52 having high thermal conductivity in FIG. 5. When the temperature of the central portion of the heating tip 51 is high, the high-temperature region 31 in FIG. 3 may extend to the region of the material 53 having low thermal conductivity.

As a combination of materials having different thermal conductivities, for example, copper, aluminum, brass or the like is used for the material 52 having relatively high thermal conductivity, and a metal such as stainless steel or titanium, a ceramic material such as alumina and silica, a high heat-resistant polymer material having a melting point or softening point higher than that of the polymer material used for the separator, such as polyimide, or a polymer material having no melting point and softening point is used for the material 53 having relatively low thermal conductivity.

Another embodiment of the heating tip is schematically shown in FIG. 6. FIG. 6(a) is a schematic vertical sectional view of the heating tip 61. FIG. 6(b) is a front view of the contact surface (heating surface) 62 of the heating tip 61 that contacts the separator. The heating tip 61 has a shape in which a cylindrical portion (thermal connection member) 63 that supplies heat of the heater block 42 that is a heat source to the heating surface 62 and a disc portion 64 having a diameter larger than that of the cylindrical portion 63 are combined. The area of the heating surface 62 of the disc part 64 is larger than the cross-sectional area of the cylindrical part 63 parallel to the heating surface 62. In the heating tip 61, since the amount of heat conducted from the heater block 42 and the heat radiation from the heating tip are different in the contact surface (heating surface) 62 of the disk portion 64, a distribution occurs in the temperature of the contact surface 62 of the heating tip 61even when the heating tip 61 is made of a single material. In the contact surface 62 of the heating tip 61, the portion that protrudes from the cylindrical portion 63 is supplied with a small amount of heat and has a large amount of heat radiation, so the temperature is lowered. As a material of the heating tip 61, for example, a metal having good thermal conductivity such as copper, aluminum, or brass is used.

In any of the heating tips described above, it is preferable to chamfer the edge of the surface in contact with the separator or to make the surface in contact with the separator a curved surface so as not to damage the separator. The curved surface can be, for example, a convex curved surface toward the separator. When the surface of the heating tip that comes into contact with the separator is a curved surface, it is preferable that the support stage is also made elastic or formed to have the curved surface corresponding to the surface of the heating tip so that the separator follows the curved surface of the heating tip.

In FIGS. 5 and 6, the contact surface of the heating tip has been described as a circle. However, the contact surface of the heating tip may be a shape that matches the shape of a necessary thermal bonding point, such as an ellipse, a rectangle, or an L shape.

### (Support Stage)

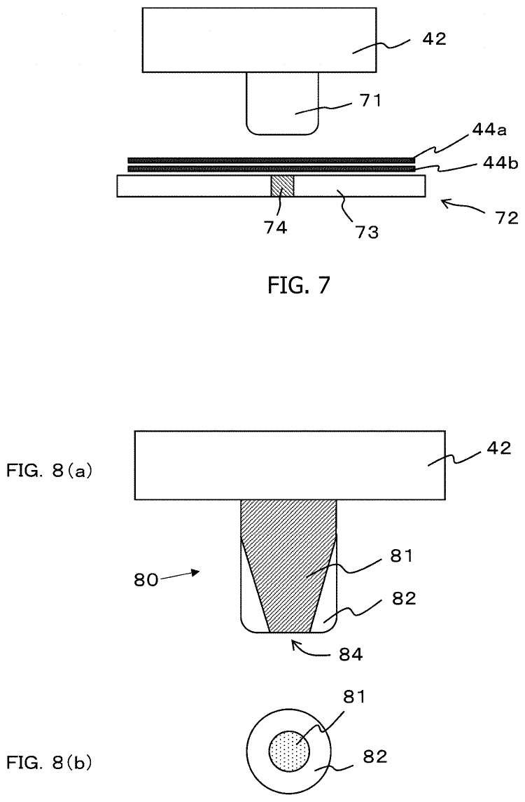

FIG. 7 is a schematic cross-sectional view for explaining the structure of the support stage in one embodiment of the thermal bonding device of the present invention. The heating tip 71 has a columnar structure made of a single material. The support stage 72 is formed of a material that can withstand the temperature of the heating tip 71. A region facing the contact surface of the heating tip 71 is formed of a high heat conductive material 73 having a relatively high thermal conductivity and a low heat conductive material 74 having a relatively low thermal conductivity. The high heat conductive material 73 is disposed on the outer side, and the low heat conductive material 74 is disposed on the inner side. Heat is not easily dissipated at a material with low thermal conductivity, and heat applied to the separator is easily dissipated at a material with high thermal conductivity. Therefore, even if there is no distribution in the temperature of the heating surface of the heating tip 71, a temperature distribution occurs in the contact region of the separator.

As another embodiment of the thermal bonding device, a recess or a through hole can be formed in the support stage 72 instead of the low heat conductive material 74 in FIG. 7. Since the thermal conductivity of air is lower than that of the high heat conductive material 73, a temperature distribution can be given to the separator. The edge of the recess or the through hole that contacts the separator is preferably chamfered or curved so as not to damage the separator.

The effect of the present invention can be obtained when at least one of the heating tip and the support stage has the structure described above. However, both the heating tip and the support stage may have the structure described above. The temperature distribution of the separator is determined by the heat given from the heating tip and the dissipation of heat to the support stage.

The thermal bonding device for the separator according to the present embodiment may have a mechanism for measuring the electrical resistance between the surface of the heating tip and the surface of the support stage by using conductors as the surface of the heating tip and the surface of the support stage. In the case of the separator made of a polymer material having a melting point, when the separator is sufficiently heated at the melting point or more during thermal bonding, a hole is opened in the separator, and the surface of the heating tip and the surface of the support stage come into contact with each other. Therefore, by measuring the electrical resistance, it can be determined that the separator has been heated to the melting point or higher.

### <Bag-Shaped Separator>

A bag-shaped separator in which the strength of the thermal bonding portion is high by thermally bonding the separator using the thermal bonding method of the separator, the heating tip for thermal bonding, and the support stage for separator described above can be obtained.

As shown in FIG. 2, the electrode plate 25 is accommodated in the bag-shaped separator 26, and a part of the current collector foil 24 is drawn out from the bag formed by the separator. The bag-shaped separator 26 accommodating the electrode plate 25 is formed by stacking two separators and thermally bonded at two or three sides leaving an opening for inserting the electrode plate 25 between the two separators. After the plate 25 is inserted, the opening can be sealed. Instead of two separators, a single separator may be folded and used. Alternatively, the electrode plate 25 is placed on one separator, another separator is piled on the electrode plate 25, and the separators are thermally bonded so as to surround the electrode plate 25, thereby in the same process forming the bag-shaped separator 26 and accommodating the electrode plate 25 therein.

The electrode plate 25 accommodated in the bag-shaped separator 26 may be either a positive electrode plate or a negative electrode plate. It is convenient to accommodate the electrode plate having a smaller planar dimension because the increase of the planar dimension of the battery element in which the electrode plate and the separator are stacked can be avoided. Further, if the width of the bag-shaped separator is the same as the width of the electrode plate of the electrode that cannot be accommodated in the bag-shaped separator, the alignment when stacking is facilitated.

### <Lithium Ion Secondary Battery>

The battery of the present invention is not particularly limited in the configuration other than the separator. Although other configurations such as a positive electrode, a negative electrode, and an electrolytic solution in the case where the embodiment is a lithium ion secondary battery will be described below, the present invention is not limited thereto.

### (Structure of Secondary Battery)

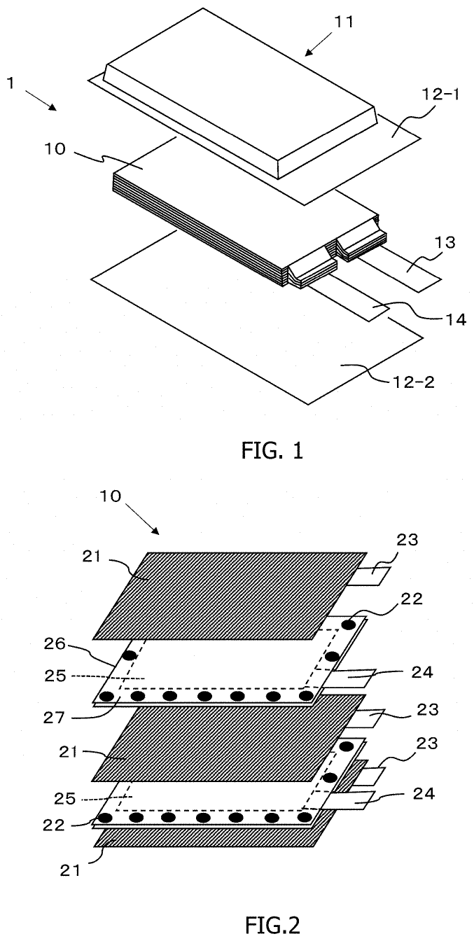

The secondary battery of the present embodiment has a structure as shown in FIG. 1. The lithium ion secondary battery 1 includes an electrode stack 10, a film outer package 11 made of film sheathing materials 12-1 and 12-2 that accommodates it together with an electrolyte, a positive electrode tab 14, and a negative electrode tab 13 (hereinafter, these are also simply referred to as “electrode tabs”).

As shown in FIG. 2, the electrode stack 10 is formed by alternately stacking bag-shaped separators 26 containing positive electrode plates 25 and negative electrode plates 21. The positive electrode plate 25 is formed by coating a positive electrode material on both surfaces of the positive electrode metal foil, and the negative electrode plate 21 is similarly formed by coating a negative electrode material on both surfaces of the negative electrode metal foil. A plurality of positive electrode plates 25 and a plurality of negative electrode plates 21 each made of a metal foil coated with an electrode material on both sides are stacked with at least one of the positive electrode plate 25 and the negative electrode plate 21 being accommodated in a bag-shaped separator 26. The electrode plate accommodated in the bag-shaped separator 26 may be either a positive electrode plate or a negative electrode plate. However, it is preferable to accommodate the electrode having a smaller planar dimension because it is possible to suppress electrode stacking displacement in the stacking process and to prevent the electrode stack 10 from having an increased planar dimension. The bag-shaped separator 26 is obtained by fixing two separators to each other by the thermal bonding region 22. FIG. 2 shows the case where the positive electrode plate 25 is accommodated in the bag-shaped separator 26. The overall outer shape of the electrode stack 10 is not particularly limited, but in this example the shape is a about flat rectangular. Details of each part constituting the electrode stack 10 will be described later.

A plurality of thermal bonding regions 22 are provided in the peripheral edge portion 27 of the separator, and have a role of stabilizing the position of the accommodated positive electrode plate 25 while forming the separator in a bag shape. When one separator is folded, one or more thermal bonding regions 22 can be provided in each of two opposing edge portions. When two separators are overlapped, the thermal bonding region 22 can be further provided at the third edge.

Each of the positive electrode plate 25 and the negative electrode plate 21 has an extended portion partially protruding from a part of the outer periphery thereof, and the extended portion 24 of the positive electrode plate 25 and the extended portion 23 of the negative electrode plate 21 are staggered so as not to interfere with each other when the positive electrode plate 25 and the negative electrode plate 21 are stacked. The extension parts 24 of the positive electrode plates 25 are stacked, and the positive electrode tab 14 is connected thereto. Similarly, with respect to the negative electrode plate 21, the extension parts 23 of the negative electrode plates 21 are stacked and connected to the negative electrode tab 13. The connection between the electrode tab and the extension part of the electrode may be performed by, for example, ultrasonic welding.

The contour shape of the battery film outer package 11 is not particularly limited, but may be a quadrangle, which is a rectangle in this example. The film sheathing materials 12-1 and 12-2 are thermally fused and bonded to each other around the electrode stack 10. The positive electrode tab 14 and the negative electrode tab 13 are drawn out from one side of the short side of the thermal bonding region. Various materials can be used for the electrode tabs 14 and 13. As an example, the positive electrode tab 14 is aluminum or an aluminum alloy, and the negative electrode tab 13 is copper or nickel. When the material of the negative electrode tab 13 is copper, the surface may be nickel-plated.

In addition, about the lead-out positions of the electrode tabs 14 and 13, the tabs may be led out from one side of the long side. Moreover, the positive electrode tab 14 and the negative electrode tab 13 may be led out from different sides. As such an example, the structure by which the positive electrode tab 14 and the negative electrode tab 13 are led out in the reverse direction from the side which opposes is exemplified.

### (Positive Electrode)

The positive electrode active material is not particularly limited as long as it is a material capable of occluding and releasing lithium, and can be selected from several viewpoints. From the viewpoint of increasing the energy density, it is preferable to include a high-capacity compound. Examples of the high-capacity compounds include lithium nickel oxide (LiNiO₂) or lithium nickel composite oxide obtained by substituting a part of Ni of lithium nickelate with another metal element. The layered lithium nickel composite oxide represented by the following formula (II) is preferred.

Li_{y}Ni₍₁₋ₓ₎MₓO₂ (II)

(where 0≤x<1, 0<y≤1.2, M is at least one kind of elements selected from the group consisting of Co, Al, Mn, Fe, Ti and B).)

From the viewpoint of high capacity, the Ni content is high, that is, in the formula (II), x is preferably less than 0.5, and more preferably 0.4 or less. Examples of such compounds include Li_{α}Ni_{β}Co_{γ}Mn_{δ}O₂ (0<α≤1.2, preferably 1≤α≤1.2, β+γ+δ=1, β≥0.7, γ≤0.2), Li_{α}Ni_{β}Co_{γ}Al₆₇O₂ (0<α≤1.2, preferably 1≤α≤1.2, β+γ+δ=1, β≥0.6, preferably β≥0.7, γ≤0.2), and in particular, LiNi_{β}Co_{γ}Mn_{δ}O₂ (0.75≤β≤0.85, 0.05≤γ≤0.15, 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, LiNi_{0.8}Co_{0.1}Al_{0.1}O₂ and the like can be preferably used.

From the viewpoint of thermal stability, it is also preferable that the Ni content does not exceed 0.5, that is, in the formula (II), x is preferably 0.5 or more. It is also preferred that the number of specific transition metals does not exceed half. Such compounds include Li_{α}Ni_{β}Co_{γ}Mn_{δ}O₂ (0<α≤1.2, preferably 1≤α≤1.2, β+γ+δ=1, 0.2≤β≤0.5, 0.1≤γ≤0.4, 0.1≤δ≤0.4). More specifically, LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), LiNi_{0.5}Co_{0.3}Mn_{0.2}O₂ (abbreviated as NCM532) and the like (however, these compounds include those in which the content of each transition metal varies by about 10%).

In addition, two or more compounds represented by the formula (II) may be used as a mixture. For example, it is also preferable to use a mixture in which NCM532 or NCM523 and NCM433 are mixed in a range from 9:1 to 1:9 (typically 2:1). Furthermore, in the formula (II), a material having a high Ni content (x is 0.4 or less) and a material having a Ni content not exceeding 0.5 (x is 0.5 or more, for example, NCM433) are mixed. As a result, a battery having a high capacity and high thermal stability can be formed.

Examples of the positive electrode active materials other than the above materials include lithium manganate having a layered structure or spinel structure such as LiMnO₂, LiₓMn₂O=(0<x<2), Li₂MnO₃, LiₓMn_{1.5}Ni_{0.5}O₄ (0<x<2); LiCoO₂ or those obtained by replacing a part of these transition metals with other metals; those lithium transition metal oxides with an excess of Li over the stoichiometric composition; and materials having an olivine structure such as LiFePO4. Furthermore, a material in which these metal oxides are partially substituted with Al, Fe, P, Ti, Si, Pb, Sn, In, Bi, Ag, Ba, Ca, Hg, Pd, Pt, Te, Zn, La, etc. can also be used. These positive electrode active materials described above can be used alone or in combination of two or more thereof.

The positive electrode can be produced by forming a positive electrode active material layer including a positive electrode active material and a binder for the positive electrode on a positive electrode current collector. Examples of the method for forming the positive electrode active material layer include a doctor blade method, a die coater method, a CVD method, and a sputtering method. After forming a positive electrode active material layer in advance, a thin film of aluminum, nickel, or an alloy thereof may be formed by a method such as vapor deposition or sputtering to form a positive electrode current collector.

### (Negative Electrode)

The negative electrode active material is not particularly limited as long as it is a material capable of reversibly receiving and releasing lithium ions with charge and discharge. Specifically, a metal, a metal oxide, carbon, etc. can be mentioned.

Examples of the metals include Li, Al, Si, Pb, Sn, In, Bi, Ag, Ba, Ca, Hg, Pd, Pt, Te, Zn, La, or alloys of two or more thereof. Moreover, these metals or alloys can be used in mixture of 2 or more thereof. In addition, these metals or alloys may contain one or more non-metallic elements.

Examples of the metal oxide include silicon oxide, aluminum oxide, tin oxide, indium oxide, zinc oxide, lithium oxide, and composites thereof. In this embodiment, it is preferable that tin oxide or silicon oxide is included as the negative electrode active material of the metal oxide, and it is more preferable that silicon oxide is included. This is because silicon oxide is relatively stable and hardly causes a reaction with other compounds. As the silicon oxide, those represented by the composition formula SiOₓ (where 0<x≤2) are preferable. In addition, one or more elements selected from nitrogen, boron, and sulfur may be added to the metal oxide, for example, 0.1 to 5% by mass. By such configuration, the electrical conductivity of a metal oxide can be improved.

Examples of carbon include graphite, amorphous carbon, graphene, diamond-like carbon, carbon nanotubes, and composites thereof. Here, graphite with high crystallinity has high electrical conductivity, and is excellent in adhesiveness and voltage flatness with a negative electrode current collector made of a metal such as copper. On the other hand, since amorphous carbon having low crystallinity has a relatively small volume expansion, it has a high effect of relaxing the volume expansion of the entire negative electrode, and deterioration due to non-uniformity such as crystal grain boundaries and defects hardly occurs.

The negative electrode can be produced by forming a negative electrode mixture layer including a negative electrode active material, a conductive material, and a negative electrode binder on a negative electrode current collector. Examples of the method for forming the negative electrode mixture layer include a doctor blade method, a die coater method, a CVD method, and a sputtering method. After forming a negative electrode mixture layer in advance, a thin film of aluminum, nickel, or an alloy thereof may be formed by a method such as vapor deposition or sputtering to form a negative electrode current collector.

### (Electrolytic Solution)

The electrolytic solution is not particularly limited, but a nonaqueous electrolytic solution containing a nonaqueous solvent and a supporting salt that is stable at the operating potential of the battery is preferable.

Examples of non-aqueous solvents include cyclic carbonates such as propylene carbonate (PC), ethylene carbonate (EC), and butylene carbonate (BC); linear carbonates such as dimethyl carbonate (DMC), diethyl carbonate (DEC), ethyl methyl carbonate (EMC), and dipropyl carbonate (DPC); propylene carbonate derivatives, aliphatic carboxylic acid esters such as methyl formate, methyl acetate and ethyl propionate; ethers such as diethyl ether and ethyl propyl ether; trimethyl phosphate; aprotic organic solvents such as phosphate esters such as trimethyl phosphate, triethyl phosphate, tripropyl phosphate, trioctyl phosphate and triphenyl phosphate, and fluorinated aprotic organic solvents in which at least a part of the hydrogen atoms of these compounds are substituted with fluorine atoms.

Among these, it is preferable to include cyclic or linear carbonates such as ethylene carbonate (EC), propylene carbonate (PC), butylene carbonate (BC), dimethyl carbonate (DMC), diethyl carbonate (DEC), ethyl methyl carbonate (MEC), dipropyl carbonate (DPC).

The nonaqueous solvent can be used singly or in combination of 2 or more kinds thereof.

Examples of the supporting salt include lithium salts such as LiPF₆, LiAsF₆, LiAlCl₄, LiClO₄, LiBF₄, LiSbF₆, LiCF₃SO₃, LiC₄F₉SO₃, LiC(CF₃SO₂)₃, and LiN(CF₃SO₂)₂. The supporting salt can be used singly or in combination of two or more.

From the viewpoint of cost reduction, LiPF₆ is preferable.

### (Film Outer Package etc.)

The material of the film outer package may be any material as long as it is stable to the electrolytic solution and has a sufficient water vapor barrier property. For example, in the case of a stacked laminate type secondary battery, it is preferable to use, as an example, a laminate film of aluminum and resin as the outer package. The outer package may be composed of a single member or may be composed of combining several members. In the present embodiment, as shown in FIG. 1, the film outer package 11 includes a first film sheathing material 12-1 and a second film sheathing material 12-2 disposed so as to face the first film sheathing material 12-1. As shown in the drawing, a configuration may be adopted in which a cup portion for housing the electrode stack 10 is formed in one film sheathing material 12-1 and a cup portion is not formed in the other film sheathing material 12-2. In addition, a configuration (not shown) in which a cup portion is formed in both film sheathing materials 12-1 and 12-2 can be employed.

### (Method for Manufacturing Secondary Battery)

The secondary battery according to the present embodiment can be manufactured according to a conventional method. An example of a method for manufacturing a stacked laminate type secondary battery will be described with reference to FIGS. 1 and 2. First, in a dry air atmosphere or an inert gas atmosphere, the positive electrode plates 25 accommodated in the bag-shaped separator 26 and the negative electrode plates 21 are stacked to produce the electrode stack 10. In the electrode stack 10, the positive electrode tab 14 is connected to the extension parts 24 of the positive electrode plates, and the negative electrode tab 13 is connected to the extension parts 23 of the negative electrode plates, and housed in the film outer package 11. In an atmosphere with little moisture, for example, in a dry air atmosphere or an inert gas atmosphere, an electrolytic solution is injected into the film outer package 11 containing the electrode stack 10 to impregnate the electrode stack 10 with the electrolytic solution. Thereafter, the opening of the film outer package 11 is sealed under a reduced pressure atmosphere to obtain a secondary battery.

### <Assembled Battery>

A plurality of secondary batteries according to the present embodiment can be combined to form an assembled battery. For example, the assembled battery can have a configuration in which two or more secondary batteries according to the present embodiment are used and connected in series, in parallel, or both. Capacitance and voltage can be freely adjusted by connecting in series and/or in parallel. The number of the secondary batteries with which the assembled battery is included can set suitably according to battery capacity or an output.

### <Vehicle>

The secondary battery or the assembled battery according to the present embodiment can be used for a vehicle. Vehicles according to this embodiment include hybrid vehicles, fuel cell vehicles, and electric vehicles (all include four-wheel vehicles (passenger cars, trucks, buses and other commercial vehicles, light vehicles, etc.), bicycles (motorbikes), and tricycles). Note that the vehicle according to the present embodiment is not limited to an automobile, and may be used as various power sources for other vehicles, for example, moving bodies such as trains.

According to the embodiment described above, the temperature of the separator, within the region where the separator is in contact with the heating tip, is distributed from the temperature not less than the melting point or the thermal softening temperature of the polymer material included in the separator to less than the melting point or the thermal softening temperature. Thereby, the location of the temperature conditions suitable for thermal bonding can be made in the contact region of the separator. By giving the temperature distribution, the allowable range of the temperature of the heating tip can be expanded. Furthermore, since the temperature continuously changes at the boundary between the thermal bonding point and the periphery of the separator, it is possible to prevent the structure from becoming discontinuous at the boundary between the thermal bonding point and periphery thereof and being easily broken. Therefore, it is possible to reduce the difficulty of finely controlling the temperature when thermally bonding a high heat-resistant separator and to increase the strength of the thermal bonding point. As a result, it is possible to provide a bag-shaped separator in which the thermal bonding point is not easily broken due to the forth applied when the battery is assembled or the deformation caused when the battery is abnormal.

### EXAMPLE

Hereinafter, the present embodiment will be specifically described by way of examples, but the present invention is not limited thereto.

### Example 1

A nonwoven fabric having a thickness of 15 μm and a porosity of 60% using PET fibers was used as a separator. The melting point of PET used in this example is 260° C.

As shown in FIG. 8, in a heating tip 80, the tip end of a copper round rod 81 having a diameter of 2 mm was processed into a conical shape to be covered with polyimide (PI) 82, and the tip end was shaved to form a surface (contact surface) 84 in contact with the separator. At the center of the contact surface 84, copper is exposed in a circle having a diameter of 0.8 mm, and the periphery of the copper is surrounded by PI. The diameter of the contact surface 84 including PI is 2 mm. The heating tip 80 is assembled to the copper heater block 42 and protrudes 3 mm from the heater block 42. The support stage on which the separator was placed was based on an aluminum plate, and a polyimide sheet having a thickness of 1 mm was fixed on the aluminum plate in order to suppress heat dissipation. The heater block 42 was heated so that the center of the region of the copper 81 on the contact surface 84 of the heating tip 80 was 270° C. At this time, the outermost side of the PI region 82 of the contact surface 84 was 250° C.

Two sheets of separators made of PET non-woven fabric had piled each other on the support stage, and the positions where the separators did not interfere with the heating tip 80 and the heater block 42 were held down so as not to be displaced. The heating tip 80 was pressed for 0.5 seconds at each bonding portion with a load of 2 Newtons (N). The interval between the bonding portions was 3 mm in both the vertical and horizontal directions. In this example, a total of nine places were bonded at intervals of 2 seconds in a 3×3 arrangement while moving one heating tip 80.

In the case of a heating tip as shown in FIG. 8, the applied load per bonding tip is preferably 0.5 N when the resin is melted, and about 1 N or more in order to push the resin when the resin is softened. If the load is more than these values, the influence of the load on the bonding strength is not so much.

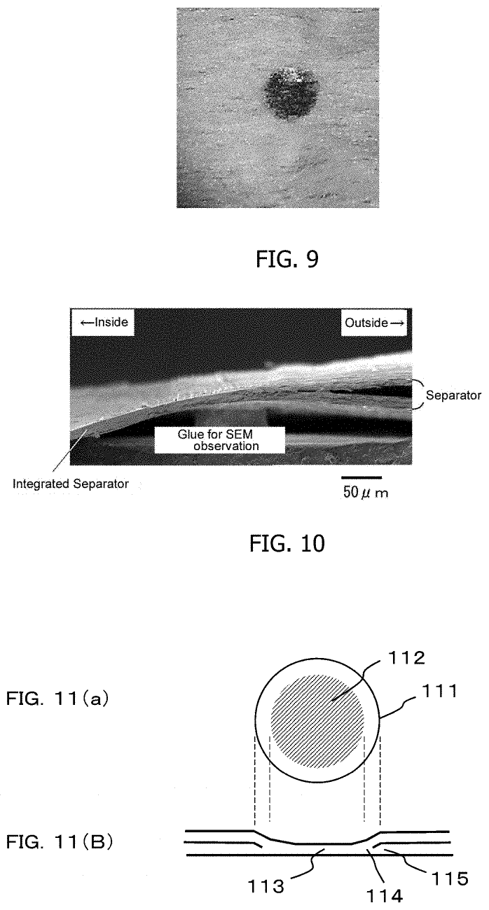

FIG. 9 is an image obtained by observing the thermal bonding region of Example 1 with an optical microscope. The separator was observed with putting on a black mount. In the thermal bonding region, the separator is melted and translucent. The translucent region has a diameter of about 1.2 mm and is smaller than the contact region of the heating tip 80. The transparency decreased toward the outside of the translucent region, and finally became white as in the case of the PET nonwoven fabric. The boundary between the melted area of the separator and the outer area is continuously connected, and the separator is not broken.

FIG. 10 shows an image obtained by observing a cross section in the vicinity of the boundary between the translucent region and the outer white region at the portion thermally bonded with a scanning electron microscope (SEM). In FIG. 10, the heating tip was brought into contact with the separator from the upper side of the SEM image. In the SEM image, the left side is a translucent region and the right side is a white region. In the translucent region (left side in FIG. 10), the fibers of the separator 101 made of the piled PET nonwoven fabric are melted, and the two separators were integrated. When forwarding to the outside of the bonding portion (on the right side in FIG. 10), the two separators are separated from each other through a region where the PET fibers are partially melted.

FIG. 11 schematically shows the thermal bonding region of Example 1. A solid line in FIG. 11(a) is a region 111 in contact with the heating tip 80, which is a thermal bonding region. A translucent region 112 is formed inside the thermal bonding region (contact region) 111. Looking at the thermal bonding structure in FIG. 11(b), from the center of the thermal bonding region 111 toward the periphery, a region 113 in which the fibers of the PET nonwoven fabric are melted, a region 114 in which the fibers are partially melted, and a region 115 in which the fibers are not melted, the structure (fusion rate of fiber) continuously changes. Since the fiber state changes continuously between the regions, the boundaries between the regions are not clear. The thickness of the thermal bonding region continuously increases from the region 113 toward the region 115.

The bonding strength of two thermally bonded separators was measured by a vertical tensile test in which a force was applied perpendicular to the separator surface. A round plate made of PE resin was fixed with double-sided tape on the front side and back side of the two bonded separators so as to cover the nine thermal bonding portions where the two separators were bonded. A plate made of PE resin fixed on the back side of the separator was fixed to the sample stage of the testing machine with double-sided tape. A round bar was fixed to the surface opposite to the separator of the PE resin round plate fixed to the front side of the separator with double-sided tape so as to cover nine thermal bonding portions. The round bar was pulled up vertically with respect to the sample stage, and the tensile force was measured when all nine thermal bonding portions were peeled off. The measurement results are shown in Table 1 together with the results of Examples 1 to 5 and Comparative Examples 1 to 4.

### Example 2

The same PET non-woven fabric separator as in Example 1 was thermally bonded by heating the heater block so that the copper area on the contact surface with the separator of the heating tip was 280° C. At this time, the outermost side of the PI region on the contact surface was 260° C. Thermal bonding was performed in the same manner as in Example 1 except for the temperature of the heating tip.

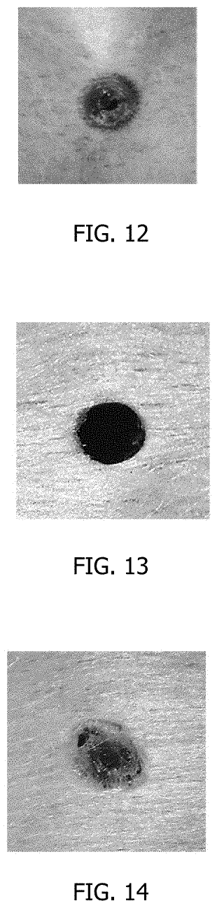

FIG. 12 is an image obtained by observing the thermal bonding portion of Example 2 with an optical microscope. There is a hole near the center of the translucent region where the PET has melted. The diameter of the translucent region was about 1.5 mm, which was larger than Example 1, but smaller than the contact surface of the heating tip. The boundary between the translucent region and the outer white region is continuously connected, and the separator is not broken. The separator thermally bonded in Example 2 was measured for bonding strength in the same manner as in Example 1.

### Example 3

A nonwoven fabric having a thickness of 25 μm and a porosity of 60% using aramid fibers was used as a separator. The aramid used in this example does not have a clear melting point but softens due to glass transition at about 280° C.

The heating tip was used by chamfering the tip of a copper round bar having a diameter of 2 mm. The heating tip is assembled in a copper heater block. The support stage on which the separator is placed is made of aluminum as a base material, and a hole having a diameter of 1.5 mm is formed at a position facing the center of the heating tip, and an alumina rod is embedded in this hole so that there is no step on the surface of the support stage. The structure of the support stage is schematically shown in FIG. 7.

Two sheets of separators made of aramid non-woven fabric had piled each other on the support stage, and the position where the separator did not interfere with the heating tip or heater block were held down so as not to be displaced during the bonding operation. The heater block was heated so that the temperature at the center of the contact surface of the heating tip with the separator was 320° C. At this time, the temperature of the outer edge portion of the heating tip was about 315° C.

The heating tip was pressed for 1 second at each bonding portion with a load of 5 N to perform thermal bonding. The interval between the bonding portions was 3 mm in both the vertical and horizontal directions. In the present example, a total of nine places were bonded at intervals of 2 seconds in a 3×3 arrangement while moving one heating tip.

When the thermal bonding portion was observed with an optical microscope, the vicinity of the center of the region in contact with the heating tip was translucent, but no hole was formed. The translucent region was smaller than the contact region and was about 1.5 mm in diameter. The transparency decreased toward the outside of the translucent region, and the white color was the same as that of the separator in the portion not subjected to the thermal bonding treatment. Therefore, although the separator is heated at a temperature higher than the softening point in the alumina portion embedded in the support stage, it can be said that the heat is dissipated toward the peripheral portion of the heating tip and the temperature is lowered to the temperature below the softening point at the peripheral portion. The separator thermally bonded in this example was measured for bonding strength in the same manner as in Example 1.

### Example 4

An aramid porous membrane having a thickness of 20 μm and a porosity of 70% was used as a separator. The aramid used in this example does not have a melting point, but a glass transition occurs at about 280° C. Thermal bonding was performed in the same manner as in Example 3 except for the separator.

When the thermal bonding portion was observed with an optical microscope, the vicinity of the center of the region in contact with the heating tip was translucent, but no hole was formed. The translucent region was smaller than the contact region and was about 1.5 mm in diameter. The transparency decreased toward the outside of the translucent region, and the white color was the same as that of the separator in the portion not subjected to the thermal bonding treatment. The separator thermally bonded in this example was measured for bonding strength in the same manner as in Example 1.

### Example 5

A nonwoven fabric having a thickness of 15 μm and a porosity of 60% using PET fibers was used as a separator. The melting point of PET used in this example is 260° C. The heater block was heated so that the temperature at the center of the contact surface of the heating tip with the separator was 280° C. At this time, the temperature of the outer edge portion of the heating tip was about 275° C. Thermal bonding was performed by contacting the separator on which the heating tips were stacked with a load of 2 N for 0.5 seconds. Other conditions were the same as in Example 3.

When the thermal bonding portion was observed with an optical microscope, the vicinity of the center of the region in contact with the heating tip became translucent and a hole was formed in the center. The translucent region had an outer shape of 1.3 to 1.5 mm and was almost the same size as the diameter of the alumina embedded in the support stage. Transparency gradually decreased from the translucent region toward the outside, and the same white color as that of the PET nonwoven fabric was obtained. The separator thermally bonded in this example was measured for bonding strength in the same manner as in Example 1.

### Comparative Example 1

As in Example 1, a nonwoven fabric having a thickness of 15 μm and a porosity of 60% using PET fibers was used as a separator. As the heating tip, the tip of a copper round bar having a diameter of 2 mm was used with its edge chamfered. The heating tip is assembled in a copper heater block. As in Example 1, the support stage on which the separator was placed was made of aluminum as a base material, and a polyimide sheet having a thickness of 1 mm was fixed on the aluminum plate to prevent heat dissipation. The heater block was heated so that the copper region on the contact surface of the heating tip was 280° C. At this time, the outermost side of the contact surface was about 275° C.

As in Example 1, the thermal bonding was performed by piling two PET non-woven fabric separators on the support stage, and pressing the position where the separator did not interfere with the heating tip or the heater block so as not to be displaced during the bonding. The heating tip was pressed for 0.5 seconds with a load of 2 N at each bonding portion. The interval between the bonding portions was 3 mm in both the vertical and horizontal directions. In this comparative example, a total of nine places were bonded at intervals of 2 seconds in a 3×3 arrangement while moving one heating tip.

FIG. 13 is an image obtained by observing the portion thermally bonded in Comparative Example 1 with an optical microscope. The separator in the entire heated portion is melted and has a hole. The bonding strength was measured in the same manner as in Example 1.

### Comparative Example 2

Two sheets of separators made of PET nonwoven fabric were thermally bonded in the same manner as in Comparative Example 1 except that the temperature of the heating tip was set to 270° C. At this time, the outermost side of the contact surface was about 265° C.

FIG. 14 is an image obtained by observing the portion thermally bonded in Comparative Example 2 with an optical microscope. The portion where the heating tip contacts is recessed, and the thickness of the separator changes discontinuously at the edge of the recess. The bonding strength was measured in the same manner as in Example 1.

### Comparative Example 3

As in Example 3, a nonwoven fabric having a thickness of 25 μm and a porosity of 60% using aramid fibers was used as a separator. Thermal bonding was performed using the same heating tip and support stage as in Comparative Example 1. As in Example 3, the heater block was heated so that the temperature at the center of the contact surface with the separator of the heating tip was 320° C. At this time, the temperature of the outer edge portion of the heating tip was about 315° C. The load of the heating tip at the time of heat bonding was set to 5N. The other conditions were the same as in Comparative Example 1 for thermal bonding. The bonding strength was measured in the same manner as in Example 1.

### Comparative Example 4

As in Example 4, an aramid porous membrane having a thickness of 20 μm and a porosity of 70% was used as a separator. Thermal bonding was performed using the same heating tip and support as in Comparative Example 1. As in Example 3, the heater block was heated so that the temperature at the center of the contact surface with the separator of the heating tip was 320° C. At this time, the temperature of the outer edge portion of the heating tip was about 315° C. The load of the heating tip at the time of heat bonding was set to 5N. The other conditions were the same as in Comparative Example 1 for thermal bonding. The bonding strength was measured in the same manner as in Example 1.

Table 1 shows the bonding strengths of Examples 1 to 5 and Comparative Examples 1 to 4. The bonding strength shown in Table 1 is a value obtained by measuring nine bonding portions together. In the case where the separator material is PET having a melting point, and in the case of an aramid having no melting point but having a softening point (glass transition temperature), the embodiment of the present invention is at least three times of the bonding strength as large as the cases of the Comparative Examples. Since the temperature applied to the separator according to the present examples does not change suddenly from the center to the outside of the bonding portion, it is presumed that the separator is hardly broken and high bonding strength is obtained. In Comparative Example 1, PET melts and holes are formed, and the bonding region is small, so the bonding strength is low. In Comparative Examples 2 to 3, no hole was formed by melting, but the separator broke at the boundary between the bonding region and the peripheral region.

TABLE 1

| | Separator Material | Bonding Strength (N) |
|---|---|---|
| Example 1 | PET | 4.5 |
| Example 2 | PET | 5.5 |
| Example 3 | Aramid | 3 |
| Example 4 | Aramid | 2.7 |
| Example 5 | PET | 5.5 |
| Comparative Example 1 | PET | 1 |
| Comparative Example 2 | PET | 0.8 |
| Comparative Example 3 | Aramid | 0.5 |
| Comparative Example 4 | Aramid | 0.8 |

As described above, the thermal bonding method and the thermal bonding device according to the present embodiment can improve the bonding strength of a separator made of a polymer material that is melted or softened by heat, so that a durable bag-shaped separator can be produced.

### Example 6

As an embodiment of the present invention, a positive electrode plate accommodated in a bag-shaped separator was produced.

A slurry is prepared by dispersing LiNi_{0.8}Co_{0.1}Mn_{0.1}O₂, a carbon conductive agent, and polyvinylidene fluoride as a binder in N-methyl-2-pyrrolidone (NMP) at a weight ratio of 92:4:4. The positive electrode active material layer was formed by applying the slurry on a current collector foil made of aluminum and drying. After forming another positive electrode active material layer on the back surface of the current collector foil made of aluminum as in same manner, the resultant was rolled to obtain a long positive electrode plate. Next, the plate was cut to 50 mm×100 mm as a dimension except an electric current extraction part. An active material layer is not formed in the current extraction portion, and extends from a region where the active material is applied with a width of 10 mm and a length of 15 mm.

Two separators made of PET nonwoven fabric used in Example 1 were prepared by cutting them to 56 mm×106 mm. The two separators were piled with the four sides aligned, and the adjacent one long side and one short side were thermally bonded under the same conditions as in Example 1. The bonding was performed with 5 mm intervals so that the center of the heating tip was positioned 1 mm inside from the edge of the separator. Next, the positive electrode plate was interposed between the two separators with protruding the current extraction portion from the short side not thermally bonded of the separator. The position of the positive electrode plate was adjusted so that the edge of the positive electrode plate excluding the extension portion for extracting current was 2 mm or more away from the edge of the separator, and the remaining two sides of the separator that had not been thermally bonded were thermally bonded. The bonding was performed with 5 mm intervals so that the center of the heating tip was positioned 1 mm inside from the edge of the separator. At this time, the region overlapping the current extraction portion extending from the positive electrode plate was not thermally bonded.

The positive electrode plate accommodated in the bag-shaped separator produced as described above can be stacked with the negative electrode plate to produce a battery element.

The present invention has been described with reference to the example embodiments and Examples, but the present invention is not limited to the above described example embodiments and Examples. Various changes that can be understood by those skilled in the art within the scope of the present invention can be made to the constitution and details of the present invention.

### (Supplement Note)

A part or all of the above exemplary embodiments may also be written as the following supplements but is not limited thereto.

### (Supplement 1)

A bag-shaped separator formed of two sheets of a separator material with piled or one sheet of the separator material with folded and piled,

wherein the separator material comprises a polymer material having a melting point or a softening point,

wherein one or more thermal bonding regions are provided at the edge of the separator material, and

wherein the thermal bonding region comprises a fused region in which the separator material is solidified again after melting or softening, and a region in which the fusion rate of the polymer material continuously decreases toward a region adjacent to the thermal bonding region from the fused region.

### (Supplement 2)

The bag-shaped separator according to supplement 1, wherein the separator material includes a fiber of a polymer material having a melting point or a softening point.

### (Supplement 3)

The bag-shaped separator according to supplement 1 or 2, wherein the region in which the fusion rate continuously decreases has a thickness that continuously increases from the fused region toward the region adjacent to the thermal bonding region.

### (Supplement 4)

The bag-shaped separator according to supplement 1 or 2, wherein the region in which the fusion rate continuously decreases has a porosity continuously increasing from the fused region toward the region adjacent to the thermal bonding region.

### (Supplement 5)

The bag-shaped separator according to supplement 1 or 2, wherein the region in which the fusion rate continuously decreases has a transparency that continuously decreases from the fused region toward the region adjacent to the thermal bonding region.

### (Supplement 6)

The bag-shaped separator according to any one of supplements 1 to 5, which has an opening in the fused region.

### (Supplement 7)

The bag-shaped separator according to any one of supplements 1 to 6, wherein the fused region is provided in a central portion, and the region in which the fusion rate continuously decreases is provided around the fused region.

### (Supplement 8)

The bag-shaped separator according to any one of supplements 1 to 7, wherein one or more of the thermal bonding regions exist in each of two opposing edge portions and have a role of stabilizing the position of an electrode plate to be accommodated.

### (Supplement 9)

The bag-shaped separator according to any one of supplements 1 to 8, wherein the fusion rate in the region in which the fusion rate continuously decreases changes from 100% to 0% at a distance equal to or greater than the thickness of the piled separators before bonding.

### (Supplement 10)

A thermal bonding method of piled separator materials that comprises a polymer material having a melting point or a softening point, the method comprising:

forming
a high temperature region heated at a first temperature higher than the melting point or softening point in a region where the piled separator materials are thermally bonded during the thermal bonding,
a low temperature region heated at a temperature lower than the first temperature and not higher than the melting point or softening point at a peripheral portion of the region to be thermally bonded, and
an intermediate region where the temperature changes from the high temperature region toward the low temperature region.

### (Supplement 11)

The thermal bonding method according to supplement 10, wherein the method comprises:

a heating step of heating a first region of a heating surface of a heating tip to a first temperature higher than the melting point or the softening point of the polymer material, and of heating a second region of the heating surface of the heating tip to a second temperature lower than the first temperature, and

an abutting step of abutting the heating surface of the heating tip on a thermal bonding region of the separator material.

### (Supplement 12)

The thermal bonding method according to supplement 11, wherein the second temperature in the heating step is a temperature equal to or lower than the melting point or the softening point of the polymer material.

### (Supplement 13)

The thermal bonding method according to supplement 11 or 12, wherein the abutting step is performed prior to the heating step.

### (Supplement 14)

A thermal bonding device for bonding a first separator material and a second separator material that are piled, comprising:

a heating tip that abuts the first separator material and heats the first separator material, and

a support stage that contacts the second separator material for supporting the piled separator materials,

wherein the heating tip comprises a core portion made of a material having relatively high thermal conductivity, and a covering portion made of a material having a relatively low thermal conductivity that covers at least a part of the core portion, and

wherein a heating surface of the heating tip that contacts the surface of the first separator material comprises both of the core portion and the covering portion.

### (Supplement 15)

A thermal bonding device for bonding a first separator material and a second separator material that are piled, comprising:

a heating tip that abuts the first separator material and heats the first separator material, and

a support stage that contacts the second separator material for supporting the piled separator materials,

wherein the area of the heating surface of the heating tip is larger than the cross-sectional area of a heat-connection member parallel to the heating surface, where the heat-connection member is connected to a heat source for supplying heat to the heating surface.

### (Supplement 16)

A thermal bonding device for bonding a first separator material and a second separator material that are piled, comprising:

a heating tip that abuts the first separator material and heats the first separator material, and

a support stage that contacts the second separator material for supporting the piled separator materials,

wherein a region opposed to the heating tip on the surface of the support stage contacting the second separator material comprises a region having relatively low thermal conductivity and a region having relatively high thermal conductivity, and the region having relatively low thermal conductivity is disposed inside the region having high thermal conductivity.

### (Supplement 17)

The thermal bonding device according to supplement 16, wherein the region having relatively low thermal conductivity is a concave portion or a through hole.

### (Supplement 18)

A power storage device comprising an electrode stack in which the bag-shaped separator according to any one of supplements 1 to 9 accommodating an electrode plate and another electrode plate having a polarity different from that of the electrode plate accommodated in the bag-shaped separator are stacked.

### INDUSTRIAL APPLICABILITY

The present invention can be widely used for power storage devices in industrial fields that require a power source. For example, power storage devices used as power sources for mobile devices such as mobile phones and note book computers, power storage devices used as power sources for electric vehicles such as electric cars, hybrid cars, electric bikes, and power-assisted bicycles, power storage devices used as a power source for a transportation medium such as trains, satellites, and submarines, and power storage devices used as an electricity storage system for storing electric power.

This application claims priority based on Japanese Patent Application No. 2017-138018 filed on Jul. 14, 2017, and the disclosure thereof is entirely incorporated herein.

### DESCRIPTION OF SYMBOLS

1 Lithium ion secondary battery
10 Electrode stack
11 Film outer package
12-1 Film sheathing material
12-2 Film sheathing material
13 Negative electrode tab
14 Positive electrode tab
21 Negative electrode plate
22, 30 Thermal bonding region
23 Extension part of negative electrode plate
24 Extension part of positive electrode plate
25 Positive electrode plate
26 Bag-shaped separator
27 Edge part
31 High temperature region (fused region)
32 Intermediate region
33 Outer edge part (peripheral edge part) (low temperature region)
34 Adjacent to the thermal bonding region (outside the outer edge part)
40 Thermal bonding device
41, 51, 61, 71, 80 Heating tip
42 Heater block
43, 72 Support stage
44a First separator (material)
44b Second separator (material)
52, 73 High heat conductive material
53, 74 Low heat conductive material
54, 62, 84 Contact surface (heating surface) with separator
63 Cylindrical portion
64 Circular disk portion
81 Copper
82 Polyimide
111 Contact region
112 Translucent region
113 Regions where fibers are melted (fused region)
114 Regions where fibers are partially melted (intermediate region)
115 Regions where fibers are not melted

1. A bag-shaped separator formed of two sheets of a separator material with piled or one sheet of the separator material with folded and piled,
wherein the separator material comprises a polymer material having a melting point or a softening point,
wherein one or more thermal bonding regions are provided at the edge of the separator material, and
wherein the thermal bonding region comprises a fused region in which the separator material is solidified again after melting or softening, and a region in which the fusion rate of the polymer material continuously decreases toward a region adjacent to the thermal bonding region from the fused region.

2. The bag-shaped separator according to claim 1, wherein the separator material includes a fiber of a polymer material having a melting point or a softening point.

3. The bag-shaped separator according to claim 1, wherein the region in which the fusion rate continuously decreases has a thickness that continuously increases from the fused region toward the region adjacent to the thermal bonding region.

4. The bag-shaped separator according to claim 1, wherein the region in which the fusion rate continuously decreases has a porosity continuously increasing from the fused region toward the region adjacent to the thermal bonding region.

5. The bag-shaped separator according to claim 1, wherein the region in which the fusion rate continuously decreases has a transparency that continuously decreases from the fused region toward the region adjacent to the thermal bonding region.

6. The bag-shaped separator according to claim 1, which has an opening in the fused region.

7. The bag-shaped separator according to claim 1, wherein the fused region is provided in a central portion, and the region in which the fusion rate continuously decreases is provided around the fused region.

8. The bag-shaped separator according to claim 1, wherein one or more of the thermal bonding regions exist in each of two opposing edge portions and have a role of stabilizing the position of an electrode plate to be accommodated.

9. The bag-shaped separator according to claim 1, wherein the fusion rate in the region in which the fusion rate continuously decreases changes from 100% to 0% at a distance equal to or greater than the thickness of the piled separators before bonding.

10. A thermal bonding method of piled separator materials that comprises a polymer material having a melting point or a softening point, the method comprising:
forming
a high temperature region heated at a first temperature higher than the melting point or softening point in a region where the piled separator materials are thermally bonded during the thermal bonding,
a low temperature region heated at a temperature lower than the first temperature and not higher than the melting point or softening point at a peripheral portion of the region to be thermally bonded, and
an intermediate region where the temperature changes from the high temperature region toward the low temperature region.

11. The thermal bonding method according to claim 10, wherein the method comprises:
a heating step of heating a first region of a heating surface of a heating tip to a first temperature higher than the melting point or the softening point of the polymer material, and of heating a second region of the heating surface of the heating tip to a second temperature lower than the first temperature, and
an abutting step of abutting the heating surface of the heating tip on a thermal bonding region of the separator material.

12. The thermal bonding method according to claim 11, wherein the second temperature in the heating step is a temperature equal to or lower than the melting point or the softening point of the polymer material.

13. The thermal bonding method according to claim 11, wherein the abutting step is performed prior to the heating step.

14-17. (canceled)

18. A power storage device comprising an electrode stack in which the bag-shaped separator according to claim 1 accommodating an electrode plate and another electrode plate having a polarity different from that of the electrode plate accommodated in the bag-shaped separator are stacked.
